(19) United States
(12) Patent Application Publication
(10) Pub. No.: US 2020/0356116 A1
(43) Pub. Date: Nov. 12, 2020

(54) METHOD FOR THE CIRCULATION OF FUEL IN A FILLING LINE OF A TANK OF AN AIRCRAFT, AND VALVE CONNECTED TO A LINE FOR IMPLEMENTING SAID METHOD

(71) Applicant: Zodiac Aerotechnics, Roche-la-Molière (FR)

(72) Inventors: Sylvain ROSSI, Saint-Jean-Bonnefonds (FR); Pierre Yves LOUBET, Saint-Étienne (FR)

(73) Assignee: Zodiac Aerotechnics, Roche-la-Molière (FR)

(21) Appl. No.: 16/641,658

(22) PCT Filed: Jul. 18, 2018
(86) PCT No.: PCT/FR2018/051834

§ 371 Date: Feb. 25, 2020

(30) Foreign Application Priority Data
Aug. 31, 2017 (FR) 1758036

(51) Int. Cl. G05D 7/01

(52) U.S. Cl. CPC G05D 7/0126; F16K 3/03

(57) ABSTRACT

Method for circulating fuel in a filling line (2) of a tank of an aircraft. The method according to the invention involves automatically and mechanically varying the cross-section for passage of the fuel until the fuel reaches a threshold maximum speed. A valve (1) connected to a filling line (2) of an aircraft fuel tank, for implementing said method. According to the invention, it comprises a device (7) for restricting the cross-section for passage of the fluid, capable, when the fuel circulates in the line (2), of automatically varying the cross-section for passage of the fuel, until the speed of the fuel reaches a threshold maximum value.

### TECHNICAL FIELD

The present invention relates to the technical field of aircraft and involves a method for fuel flow in a filling pipe of an aircraft tank and a self-adjusted valve connected to a pipe for implementation of said method.

### PRIOR ART

In the aeronautics field, and particularly in that of fuel flow in tank filling pipes, the appearance of an electrostatic charge in the fuel must be avoided, since that would lead to a risk of sparking in the fuel vapors and of explosion.

Thus, the speed of filling tanks must be limited. The current regulation, in particular § 8.f.(2).(b) of reference document FAR (Federal Aviation Regulation, Title 14 Code of Federal Regulations) Chapter I Subchapter C section 25.981 indicates that the fuel speed inside a tank filling pipe is acceptable if it is included between 6 and 7 m/s.

To limit the flow speed of fuel in the filling pipes, it is known to install means of flow restriction in the filling pipes, in order to limit the fuel flow rate and speed, which are closely connected.

These means of restriction, in particular in the form of graded openings, are designed and sized to restrict the passage section of the filling pipe and reduce the flow rate and filling speed of the fuel, by considering the most restrictive parameters related to the fuel, specifically hot fuel having a temperature of 55° C.

The disadvantage of this solution resides in the fact that in practice, when the fuel is colder, and therefore more viscous, the filling speed and flow rate are found to be too limited, which extends the filling time for the fuel tanks.

### BRIEF DESCRIPTION OF THE INVENTION

One of the goals the invention is therefore to remedy the disadvantages from the prior art by proposing a method for fuel circulation in a filling pipe for an aircraft tank with which to optimize the filling time of said tank according to the nature of the circulating fuel, in particular the temperature thereof. The objective is to minimize the filling time while providing optimal safety.

For this purpose and according to the invention, a method for fuel flow in a filling pipe for an aircraft tank is proposed, remarkable in that it consists of automatically and mechanically varying the fuel passage section until the fuel reaches a maximum speed threshold.

In that way, reducing the passage section increases the loss of load in the pipe and reduces the fuel flow rate in the pipe. The fluid flow rate and speed are directly related by well-known physical relationships. The fuel passage section is controlled in such a way that said section is reduced when the fuel flow speed is over a predefined maximum threshold, and said section is increased when the fuel flow speed is below the predefined maximum threshold, until the fuel reaches said maximum speed threshold.

Advantageously, the fuel passage section varies automatically depending on a pressure difference between two points in the pipe. The location of these two points can be selected such that the pressure difference varies proportionally to the fuel speed in the pipe.

Preferably, the passage section is automatically restricted when the fuel flow speed is zero. With this feature, the fuel flow method can be made safe.

One of the purposes of the invention is also to provide a self-adjusted filling valve for implementing said method, with which to optimize the filling time of said tank as a function of the nature of the fuel flowing.

For this purpose and according to the invention, a valve connected to a filling pipe for an aircraft fuel tank is proposed, notable in that it comprises a device for restriction of the fuel passage section, such as an adjustable diaphragm, able, when the fuel flows in the pipe, to automatically vary the section for fuel passage until the fuel speed reaches a maximum threshold value.

In this way, the filling time is minimized. In practice, the fuel flow conditions, in particular the fuel temperature, are less restrictive than those assumed by regulation. Thus, when the fuel has a temperature below 55° C., the invention serves to accelerate the filling, compared to the existing solution with a graded opening, without risk of appearance of electrostatic charge. Reducing the filling time of the aircraft tanks reduces the time the aircraft is immobile on the ground.

Advantageously, the restriction device is subject to means of actuation of the restriction device depending on a pressure difference between two points in the pipe.

Preferably, the means for actuation comprise a master cylinder comprising a piston mounted slidably between a first chamber and a second chamber of variable volumes. The first and second chambers are each connected to pipe pressure at least at one point. The piston is mechanically connected to the restriction device such that the sliding of the piston leads to actuation of the restriction device.

In this way, the device according to the invention has a simple and rational construction with which to reduce the cost of production thereof and maintenance thereof.

According to specific embodiments, the piston is subject to an elastic restoring member which tends to move the piston in a direction corresponding to a maximum or minimum opening of the restriction device.

Advantageously, the first and second chambers of the master cylinder are connected to pipe pressure via a Prandtl tube. In other words, one of the chambers is connected to pipe pressure via a total pressure opening, and the other pipe is connected to pipe pressure via a static pressure opening. In that way, the piston directly experiences a pressure difference which is a function of the fuel speed in a way that is well known to a person skilled in the art.

According to another embodiment, the pipe has a Venturi tube and the first and second chambers of the piston are respectively connected to the pressure at a widened area and at a narrowed area of the Venturi tube. Thus, according to this embodiment, the piston also directly experiences a pressure difference that is a function of the fuel speed.

Again preferably, the first chamber of the master cylinder is connected directly and hydraulically to the pipe. The second chamber of the master cylinder is hydraulically connected to a secondary cylinder. The secondary cylinder has a piston mounted slidably between a first chamber and a second chamber of variable volumes. The first chamber of the secondary cylinder comprises an elastic restoring member which tends to push the piston back towards the second chamber and is directly and hydraulically connected to the narrowed area of the Venturi tube. The second chamber of the secondary cylinder is directly and hydraulically connected to a widened area of the Venturi tube. The second chamber of the master cylinder is, according to the sliding of the piston, hydraulically connected either with the first chamber of the secondary cylinder, or partially with the second chamber of the secondary cylinder. In other words, the secondary cylinder can connect the second chamber of the master cylinder with a widened area of the Venturi tube, so as to create a hydraulic circuit between the widened area of the Venturi tube, the second chamber of the secondary cylinder, the second chamber of the master cylinder and the narrowed area of the Venturi tube.

With this embodiment, the passage section can be changed only if the fuel speed exceeds a predefined minimum threshold.

The invention serves to regulate and maximize the flow rate whatever the condition of use—meaning whatever the temperature of the fuel flowing in the filling pipe—thereby allowing reduction of the filling time of the fuel tank.

### BRIEF DESCRIPTION OF THE FIGURES

Further characteristics and advantages of the invention will become apparent from the description provided below, which is for reference only and is in no way restrictive, with reference to the accompanying figures, in which:

FIG. 1 is a schematic representation of the first embodiment of the valve according to the invention, with a master cylinder in minimum constriction position;

FIG. 2 is a schematic representation similar to that of FIG. 1 with the master cylinder in maximum constriction position;

FIG. 3 is a schematic representation of the pipe in transverse section, corresponding to the section A-A of FIG. 1 with the adjustable diaphragm in minimum constriction position;

FIG. 4 is a schematic representation of the pipe in transverse section, corresponding to the section B-B of FIG. 2 with the adjustable diaphragm in maximum constriction position;

FIG. 5 is a simplified representation of the valve according to a second embodiment, comprising a Prandtl tube;

FIG. 6 is a schematic representation corresponding to a third embodiment and showing the valve when the fuel is not flowing in the pipe, with the master cylinder in maximum constriction position;

FIG. 7 corresponds to the third embodiment and represents the valve when fuel is flowing at low velocity in the pipe, with the master cylinder in minimum constriction position;

FIG. 8 corresponds to the third embodiment and shows the valve when fuel is flowing at a significant velocity in the pipe, where the master cylinder is in partially closed position so as to establish a hydraulic circuit between the secondary and master cylinders.

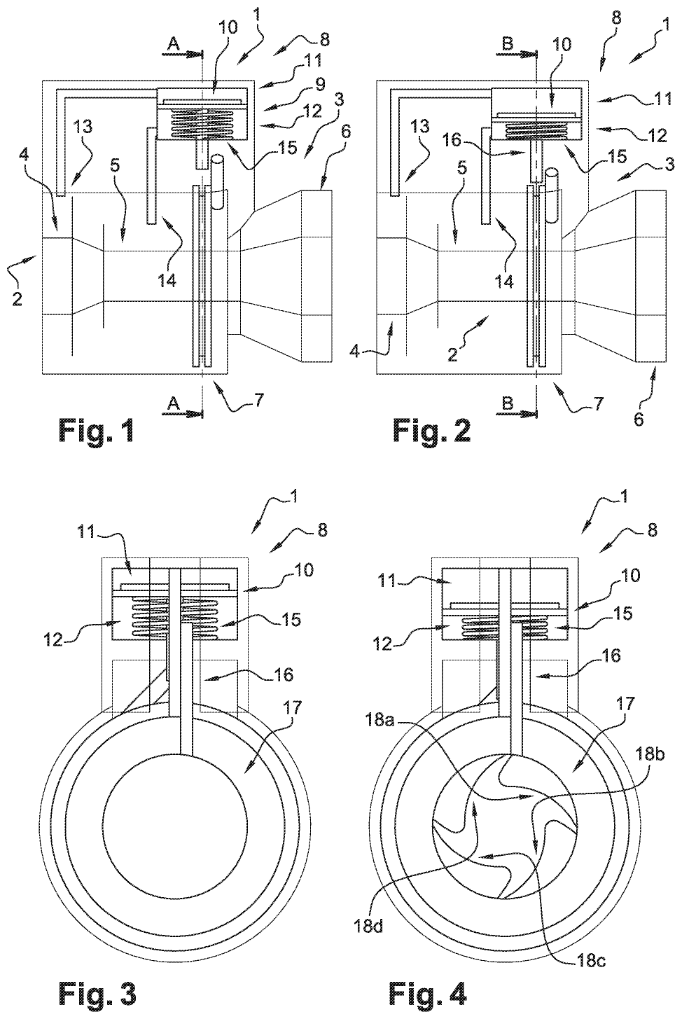

In FIGS. 1 to 8, the same elements bear the same numerical references.

### DETAILED DESCRIPTION OF THE INVENTION

The invention relates to a valve (1) connected to a filling pipe (2) for an aircraft fuel tank.

Referring to FIG. 1 showing a first embodiment of the invention, the pipe (2) has a Venturi tube (3), comprising a widened inlet area (4), a narrowed area (5) and a widened outlet area (6). A device for restriction (7) of the fuel passage section is arranged, for example, in the narrowed area (5) of the pipe (2). The restriction device (7) is mechanically connected to actuation means (8) which comprise a master cylinder (9). The master cylinder (9) has a piston (10) mounted slidably between a first chamber (11) and a second chamber (12) of variable volumes. The first chamber (11) is connected to pressure in the widened area (4) of the pipe (2) via a static pressure opening (13), and the second chamber (12) is connected to pressure in the narrowed area (5) of the pipe (2) via a static pressure opening (14). The piston (10) is subject to a spring (15) which tends to move the piston (10) into a position corresponding to a maximum opening of the restriction device (7). In this embodiment, this position corresponds to the absence of fuel flowing in the pipe (2).

With reference to FIG. 2, when the fuel flows in the pipe (2), the fuel speed in the widened areas (4, 6) of the pipe (2) is smaller than in the narrowed area (5). In that way, as described by the Bernoulli formula, the static pressure in the narrowed area (5) decreases. The more the fuel speed in the pipe (2) increases, the more the pressure difference increases. Thus, the piston (10) directly experiences said pressure difference. When the pressure in the second chamber (12) decreases, the fuel pressure in the first chamber (11) tends to move the piston (10) against the spring (15). The greater the pressure difference, the greater the force due to the pressure difference and the farther the piston (10) is displaced. The piston (10) is mechanically connected to the restriction device (7) via, for example, a control rod (16). Thus, the section for passage of fuel varies automatically until the fuel speed reaches a preset maximum threshold value.

As shown in FIGS. 3 and 4, the restriction device (7) has, for example, the shape of an adjustable iris aperture diaphragm (17). The linear motion of the control rod (16) results in rotation of a plurality of blades (18a, 18b, 18c, 18d) for progressively restricting the section for passage in the pipe (2). In FIG. 3, the adjustable diaphragm (17) is in minimal constriction position, with the piston (10) in top position, and, in FIG. 4, the diaphragm (17) is in partial constriction position with the piston (10) in bottom position. The stiffness of the spring (15) is chosen such that the valve (1) is in equilibrium when the fuel speed reaches for example 7 m/s.

Of course, and without leaving the scope of the invention, the restriction device (7) can be a knife gate valve, an elastomer gate valve, a ball valve, or the like.

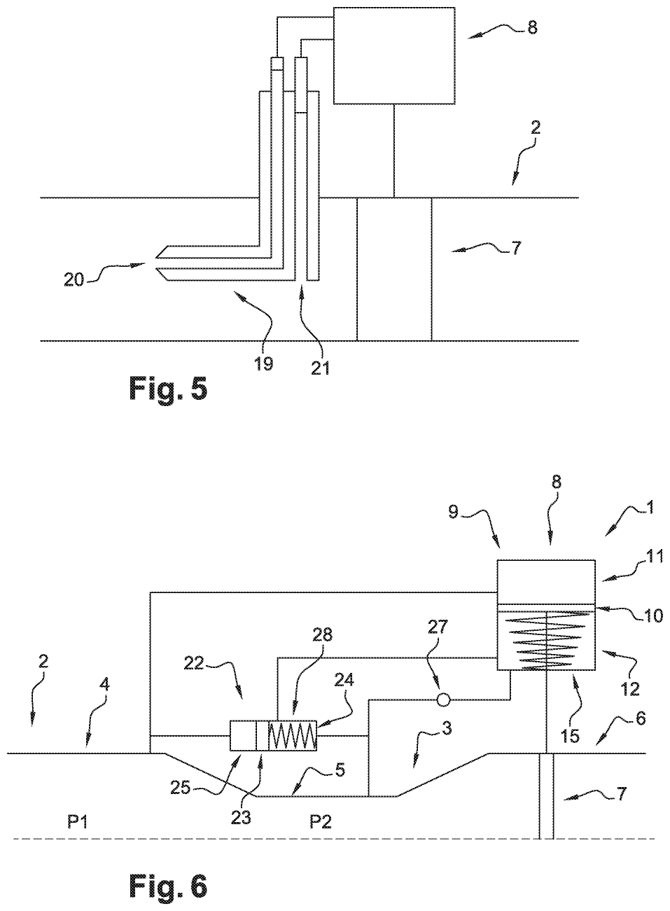

We now refer to FIG. 5, which shows a second embodiment. The means of actuation (8) and the restriction device (7) are identical to those from the first embodiment and will not be described again. The pipe (2) has a constant section and inside comprises a Prandtl tube (or Pitot tube) (19) hydraulically connected to the means of actuation (8). Because of the Prandtl tube (19), the piston (10) is subject to the pressure difference between the total pressure of the fuel which is flowing in the pipe near the first opening (20) and the static pressure of the fuel near a second opening (21). In a known way, this pressure difference is also related to the fuel flow speed in the pipe (2). Thus, the section for passage of fuel varies automatically until the fuel speed reaches a preset maximum threshold value, for example 7 m/s.

Referring to FIGS. 6, 7 and 8 showing a third embodiment of the invention, the pipe (2) has a Venturi tube (3), comprising a widened inlet area (4), a narrowed area (5) and a widened outlet area (6). The restriction device (7) is arranged in the widened outlet area (6). The valve (1) has a master cylinder (9) comprising the piston (10) mounted slidably between the first chamber (11) and the second chamber (12) of variable volumes. The piston (10) is subject to a spring (15) which tends to move the piston (10) into a position corresponding to a minimum opening of the restriction device (7). It should be noted that unlike the previous embodiments, the top position of the piston (10) corresponds to the maximum constriction whereas the bottom position corresponds to the minimum constriction.

The first chamber (11) of the master cylinder (9) is directly and hydraulically connected to the widened area (4) of the pipe (2). The second chamber (12) thereof is hydraulically connected to a secondary cylinder (22).

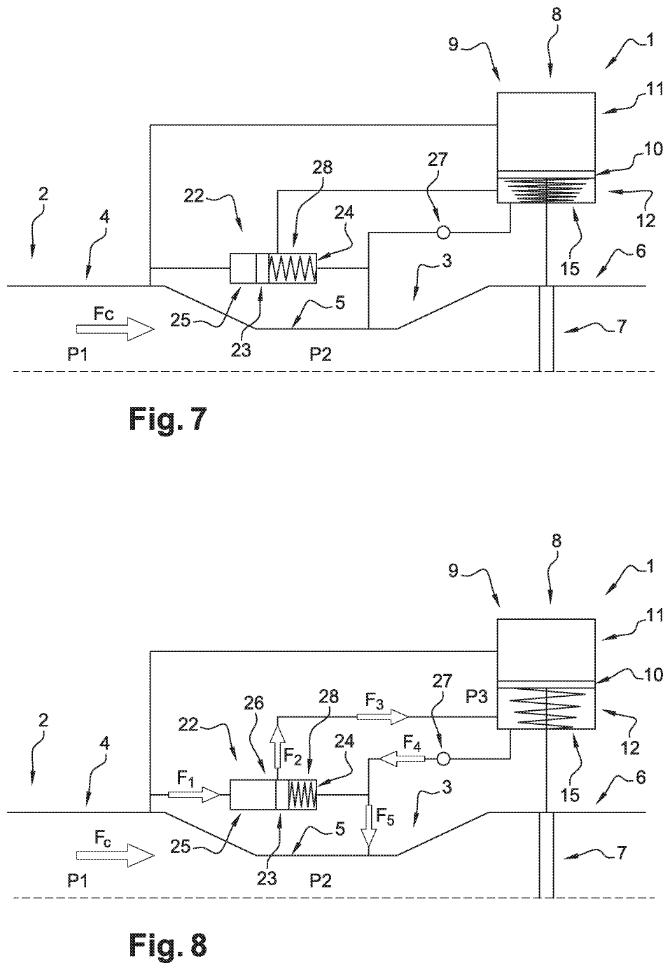

The secondary cylinder (22) has a piston (23) mounted slidably between a first chamber (24) and a second chamber (25) of variable volumes. The first chamber (24) of the secondary cylinder (22) is directly and hydraulically connected to the narrowed area (5) of the Venturi tube (3) and comprises a spring (28) which tends to push the piston (23) of the secondary cylinder (22) back towards the second chamber (25). The second chamber (25) of the secondary cylinder (22) is directly and hydraulically connected to a widened area (4) of the Venturi tube (3). The second chamber (12) of the master cylinder (9) is, according to the sliding of the piston (23), hydraulically connected either with the first chamber (24) of the secondary cylinder (22; see FIGS. 6 and 7), or partially with the second chamber (25) of the secondary cylinder (22; see FIG. 8) to create a fuel leak.

When the secondary cylinder (22) connects the second chamber (12) of the master cylinder (9) with a widened area (4) of the Venturi tube (3), a hydraulic circuit is established between the widened area (4) of the Venturi tube (3), the second chamber (25) of the secondary cylinder (22), the second chamber (12) of the master cylinder (9) and the narrowed area (5) of the Venturi tube (3), such that fuel can circulate between these elements, as shown by the arrows F₁ to F₅. To prevent the backflow of fuel from the pipe (2) to the second chamber (12) of the master cylinder (9), an anti-backflow valve (27) is advantageously placed between the narrowed area (5) of the pipe (2) and said chamber (12).

Without fuel flow (see FIG. 6), the restriction device (7) is in position of maximum closure constriction. With this embodiment, the passage section can be changed only if the fuel speed exceeds a predefined minimum threshold, and also serves to make the valve (1) safe against failure of the actuation means (8).

When the fuel starts to flow (see FIG. 7), as shown by the arrow F_{c}, a pressure difference appears between the static pressure P1 of the widened area (4) and the static pressure P2 in the narrowed area (5). In this way, the piston (10) of the master cylinder (9) is pushed towards the second chamber (12) by said pressure difference and leads to the actuation of the restriction device (7) in minimum constriction position.

When the fuel speed increases and reaches the limit value, for example 7 m/s (see FIG. 8), the pressure difference between the static pressure P1 in the widened area (4) and the static pressure P2 in the narrowed area (5) increases. In this way, the piston (23) of the secondary cylinder (22) is pushed by said difference towards the first chamber (24) of the secondary cylinder (22) against the spring (28) and connects the expanded area (4) of the Venturi tube (3), the second chamber (25) of the secondary cylinder (22), the second chamber (12) of the master cylinder (9) and the narrowed area (5) of the Venturi tube (3). A pipe (26) that is located between the second chamber (25) of the secondary cylinder (22) and the second chamber (12) of the master cylinder (9) comes to be partially blocked by the piston (23) of the secondary cylinder (22). Thus, because of the loss of load, the pressure P3 in the second chamber (12) of the master cylinder (9) is higher than the pressure P2, but lower than the pressure P1. In that way, the force due to the pressure difference on the piston (10) of the master cylinder (9) decreases, and the spring (15) moves the piston (10) upward to put the restriction device (7) into position for partial constriction. As a result, the fuel flow rate and speed are reduced. The stiffness of the springs (15, 28) is chosen such that the valve (1) is in equilibrium when the fuel speed is equal to 7 m/s. In this way, the section for passage of fuel varies automatically until the fuel speed reaches a maximum threshold value, for example 7 m/s. The fuel speed does not exceed this speed limit and the flow rate is maximal whatever the nature, in particular the temperature, of the fuel flowing in the pipe (2).

What is claimed is:

1. A method for fuel flow in a filling pipe (2) for an aircraft tank, characterized in that it consists of automatically and mechanically varying the fuel passage section until the fuel reaches a maximum speed threshold.

2. The method according to claim 1, characterized in that the fuel passage section varies automatically depending on a pressure difference between two points in the pipe (2).

3. The method according to claim 1, characterized in that the passage section is automatically restricted when the fuel flow speed is zero.

4. The valve (1) connected to a filling pipe (2) for an aircraft fuel tank for the implementation of the method according to claim 1 characterized in that it comprises a device for restriction (7) of the fuel passage section, able, when fuel flows in the pipe (2), to automatically vary the section for fuel passage until the fuel speed reaches a maximum threshold value.

5. The valve (1) according to claim 4, characterized in that the restriction device (7) is subject to means of actuation (8) of the restriction device (7) depending on a pressure difference between two points in the pipe (2).

6. The valve (1) according to claim 5, characterized in that the means for actuation (8) comprise a master cylinder (9) comprising a piston (10) mounted slidably between a first chamber (11) and a second chamber (12) of variable volumes, where the first (11) and second (12) chambers are each connected to pipe (2) pressure at least at one point and where the piston (10) is mechanically connected to the restriction device (7) such that the sliding of the piston (10) leads to actuation (8) of the restriction device (7).

7. The valve (1) according to claim 6, characterized in that the piston (10) is subject to an elastic restoring member (15) which tends to move the piston (10) in a direction corresponding to a maximum or minimum opening of the restriction device (7).

8. The valve (1) according to claim 6, characterized in that the first (11) and second (12) chambers of the master cylinder (9) are connected to pipe (2) pressure via a Prandtl tube (19).

9. The valve (1) according to claim 6, characterized in that the pipe (2) has a Venturi tube (3) and the first (11) and second (12) chambers of the piston are respectively connected to the pressure at a widened area (4) and at a narrowed area (5) of the Venturi tube (3).

10. The valve (1) according to claim 9, characterized in that the first chamber (11) of the master cylinder (9) is connected directly and hydraulically to the pipe (2), and the second chamber (12) is connected hydraulically to a secondary cylinder (22) comprising a piston (23) mounted slidably between a first chamber (24) and a second chamber (25) of variable volumes, the first chamber (24) of the secondary cylinder (22) comprises an elastic restoring member (28) which tends to push the piston (23) back towards the second chamber (25) and is connected directly and hydraulically to the narrowed area (5) of the Venturi tube (3), the second chamber (25) of the secondary cylinder (22) is connected directly and hydraulically to a widened area (4) of the Venturi tube (3), the second chamber (12) of the master cylinder (9) is, according to the sliding of the piston (23), hydraulically connected either with the first chamber (24) of the secondary cylinder (22), or partially with the second chamber (25) of the secondary cylinder (22).

11. The valve (1) according to claim 4, characterized in that the restriction device (7) is an adjustable diaphragm (17).
